(19) United States
(12) Patent Application Publication
(10) Pub. No.: US 2012/0251777 A1
(43) Pub. Date: Oct. 4, 2012

(54) COMPONENT FOR A TURBOMACHINE AND METHOD FOR MANUFACTURING SUCH A COMPONENT

(75) Inventors: Sophie Betty Claire Duval, Zurich (CH); Daniel Beckel, Wettingen (CH); Pierro-Daniele Grasso, Niederweningen (CH); Alexander Stankowski, Wurenlingen (CH); Jaroslaw Leszek Szwedowicz, Bad Zurzach (CH)

(73) Assignee: ALSTOM TECHNOLOGY LTD, Baden (CH)

(21) Appl. No.: 13/425,658

(22) Filed: Mar. 21, 2012

(30) Foreign Application Priority Data
Apr. 4, 2011 (CH) 00604/11

(51) Int. Cl. B32B 5/16; B32B 18/00; C09D 1/00; B05D 1/10; H05B 6/00; B32B 5/02; B32B 15/02

(52) U.S. Cl. 428/144; 428/221; 442/59; 427/446; 264/482; 106/287.17; 106/287.1

(57) ABSTRACT

A component for use in an engine in which the component is subjected to at least one of a high temperature, a corrosive atmosphere, an oxidizing atmosphere, a high mechanical load, a cyclic thermal load and transient conditions such that the component is prone to crack formation and propagation. At least one base material includes a self healing system in a form of an added active phase, the self healing system including at least one of a melting point depressant and a substance having a softening or a melting point below or within a range of an operating temperature of the component.

### CROSS REFERENCE TO PRIOR APPLICATIONS

Priority is claimed to Swiss Patent Application No. CH 00604/11, filed on Apr. 4, 2011, the entire disclosure of which is hereby incorporated by reference herein.

### FIELD

The present invention relates to the technology of turbomachines, a component for a turbomachine and a method for manufacturing such a component.

### BACKGROUND

During service, the components in a turbomachine, in particular (but not only) gas turbine hot gas path components like heat shields, liners, blades and vanes, or hot components of other engines are subjected to high temperature, corrosive and oxidizing atmosphere and mechanical load. Due to these extreme conditions, the base metal, brazed regions and metallic coatings of components are prone to crack formation and propagation. FIG. 1 is a photograph showing the coarsening of the grain boundary 30 in a base metal at the origin of crack formation in a depletion zone. FIG. 2 is a photograph showing a thermo-mechanical fatigue crack 13, which is initiating in a bond coat 11. The crack 13 propagates into base metal 12 (=substrate) and into a thermal barrier coating (TBC) 10.

Cracking is a limiting factor for the lifetime of a turbomachine component. In addition, the reconditioning efforts and the scrap rate are also highly dependent on the presence, size and location of cracks at the end of a service interval.

Document EP 1 591 562 A2 describes a structure comprising at least one metallic surface provided with cathodic protection and a protective coating for said surface, said coating comprising a polymer including micro-capsules containing compounds which are responsive to the electric field generated by the cathodic protection and which are capable of reacting in an alkaline medium to form a protective layer on the surface of the structure. The structures of the disclosure may, for example, be buried or submerged pipelines, reservoirs, boats or port or marine facilities.

Document EP 1 743 957 A1 describes a method for the treatment of the tip of a turbine blade. In the operation of turbines which are used for example as engines for aeroplanes or as land based industrial gas turbines, it is desirable, from the point of view of efficiency to keep the clearance between the tips of the turbine blades and the corresponding seals in the housing as small as possible. For this reason, the tips of the turbine blades are provided with abrasive coatings, which make it possible for the tips of the turbine blades to cut their own way into the abradable seals when rotating, at least in the first hours of operation. The abrasive coatings usually contain hard grinding or cutting particles, which cut into the seal. These particles can be embedded into an oxidation resistant metallic matrix, which is provided on the surface of the tip of the blade. The document proposes a method for the treatment of the blade tip of a turbine blade in which silicon carbide (SiC) particles are bound to the surface of a turbine blade for the production of an abrasive coating, with a self-healing barrier layer being produced on the SiC particles.

Document EP 1 840 245 describes components for high temperature applications, for example turbine blades and combustion chamber walls of gas turbines, having protective layers against oxidation and corrosion. Such layers consist, for example, of an alloy of the MCrAlX type, a protective aluminum oxide layer being formed on this MCrAlX layer. In this case, the aluminum of the MCrAlX alloy diffuses onto the surface of the MCrAlX layer, so that the MCrAlX alloy undergoes a depletion of the element aluminum. However, a preventatively enhanced fraction of aluminum in the MCrAlX alloy from the outset, in order to counteract depletion, leads to poorer mechanical properties of the MCrAlX layer. To have a longer protective action the document proposes to use a matrix with particles for a component or a layer, comprising a matrix material having at least one metal element, wherein the particles have either an oxide, a nitride, a boride, aluminum nitride or aluminum oxynitride, or wherein the compound of the particle has a Si—O—C-Me compound, and the metal element in the compound has a non-stoichiometric fraction.

Document U.S. Pat. No. 6,068,930 describes thermostructural composite materials comprising fibre reinforcement known as a fibre “preform” in which the fibres are made of a refractory material such as carbon or ceramic, and a matrix that fills in, at least in part, the pores initially present in the fibre reinforcement. Such materials are known for their good mechanical properties, enabling them to be used as structural elements, and for their ability to conserve these properties at high temperatures, in particular when the matrix is made of ceramic. The document describes improving the ability of a ceramic matrix thermostructural composite material having carbon or carbon-coated fibre reinforcement to withstand oxidation by sequencing the matrix so that cracking of the matrix can be retarded as much as possible. This is achieved by a matrix that is at least partially sequenced with alternating layers of relatively flexible anisotropic material capable of deflecting any cracks that reach them, and layers of relatively rigid ceramic material, said relatively flexible material having a rigidity less than that of the relatively rigid ceramic material. Each of a plurality of elementary sequences of the matrix comprises a relatively flexible layer of the relatively flexible anisotropic material and a relatively rigid ceramic layer, each of the plurality of elementary sequences having a thickness that increases going from the elementary sequence closest to the fibres to the elementary sequence furthest from the fibres, with at least the elementary sequence closest to the fibres coating them in substantially individual manner. The thickness of the relatively flexible layers of the relatively flexible anisotropic material, and the anisotropic character and the capacity for elastic deformation in shear and transversely of the material(s) constituting said layers are such that the matrix of the composite material is free from cracking, at least at the end of the process of building up the composite material.

Document US 2002/0155316 A1 describes composite MCrAlX-based coatings for superalloy substrates. To have a coating that possesses ductility to minimize crack propagation, while still preserving the necessary oxidation resistance conferred by the presence of an adequate amount of aluminum in the coating, the document proposes the use of composite coatings over a superalloy substrate that can significantly improve performance of parts fabricated there from. These composite MCrAlX coatings are designed to have a high aluminum concentration while retaining desired ductility. These coatings include a MCrAlX phase, and an aluminum-rich phase having an aluminum concentration higher than that of the MCrAlX phase, and including an aluminum diffusion-retarding composition. The aluminum rich phase supplies aluminum to the coating at about the same rate that aluminum is lost through oxidation, without significantly increasing or reducing the concentration of aluminum in the MCrAlX phase of the coating. The result is excellent oxidation resistance, without an increase in brittleness.

Document WO 2008/140479 A2 describes a thermal barrier coating system, which includes a first layer of ceramic insulating material disposed on a substrate surface and a second layer of ceramic insulating material disposed on the first layer of ceramic insulating material. The second layer of ceramic insulating material includes one or more crack arrestors therein. A third layer of ceramic insulating material is disposed on the second layer of ceramic insulating material, which is configured as a sacrificial layer to absorb mechanical shock generated in the event of a foreign object collision with the third layer. The one or more crack arrestors in the second layer can avoid propagation towards the first layer of one or more cracks that can form in the event of the foreign object collision with the third layer.

Document WO 2008/140481 A1 describes a thermal barrier coating system capable of self-healing, which has a substrate, a metal-based advanced bond coat overlying the substrate and a ceramic top coat overlying the bond coat. The bond coat comprises ceramic oxide precursor materials capable of forming a non-alumina ceramic oxide composition when exposed to a thermally conditioning oxidizing environment. Embodiments of such bond coat comprise rare earth elements in a range of 1-20 weight percent, and Hf in a range of about 5 to 30 weight percent or Zr in a range of about 2 to 20 weight percent. Examples of self-healing TBC systems are provided using such bond coat or its advanced bond coat chemistries in combination with conventional bond coats or conventional bond coat chemistries.

WO 2009/127852 A1 describes a composite structure comprising: a first stack comprising a plurality of plies of composite material and at least one ply of self-healing material, the ply of self-healing material comprising a plurality of containers each containing a curable healing liquid; and a second stack comprising a plurality of plies of composite material, the stacks being joined together at a bond line. By placing a ply of self-healing material in one of the stacks (preferably relatively close to the bond line) the ply of self-healing material can resist the propagation of cracks between the first stack and the second stack.

Finally, document WO 2009/156376 A1 describes a component with a self-healing surface layer or a self-healing enamel or a coating powder. According to the disclosure, the self-healing is guaranteed through a reactive substance that is encased inside of sheathed particles. Damage to the enamel layer leads to the destruction of the sheathing, preferably under the influence of a catalytic material, so that the encased fluid enamel can escape. Under the effect of UV light, the fluid enamel cures and closes the resultant crack.

As described above, some documents describe solutions to prevent crack formation or to stop the crack propagation or even to heal cracks during service.

### SUMMARY OF THE INVENTION

In an embodiment, the present invention provides a component for use in an engine in which the component is subjected to at least one of a high temperature, a corrosive atmosphere, an oxidizing atmosphere, a high mechanical load, a cyclic thermal load and transient conditions such that the component is prone to crack formation and propagation. At least one base material includes a self healing system including an added active phase including at least one of a melting point depressant and a substance having a softening or a melting point below or within a range of an operating temperature of the component.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a photograph of the coarsening of the grain boundary at the origin of crack formation in a depletion zone of an exemplary turbomachine component;

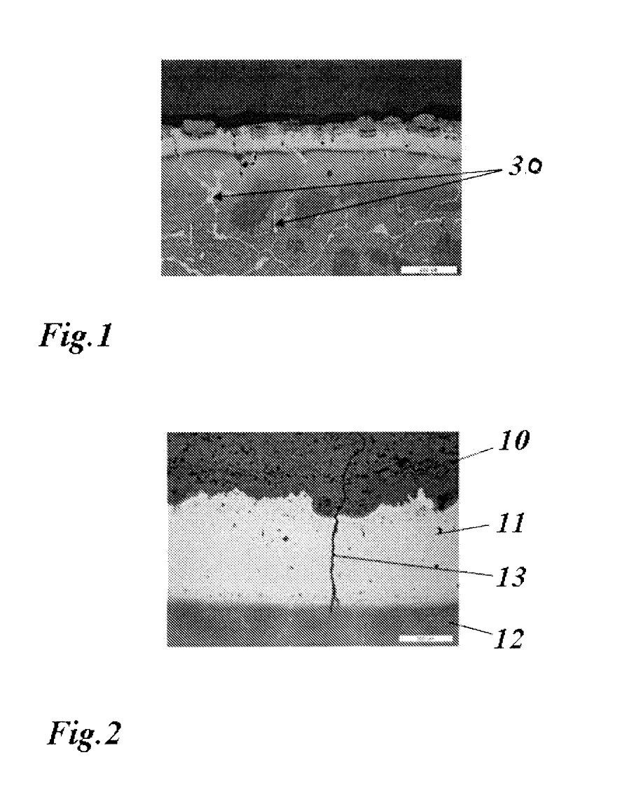

FIG. 2 shows a photograph of thermo-mechanical fatigue crack initiated at the surface of a bond coat, which crack is propagating into both the ceramic layer and the base metal;

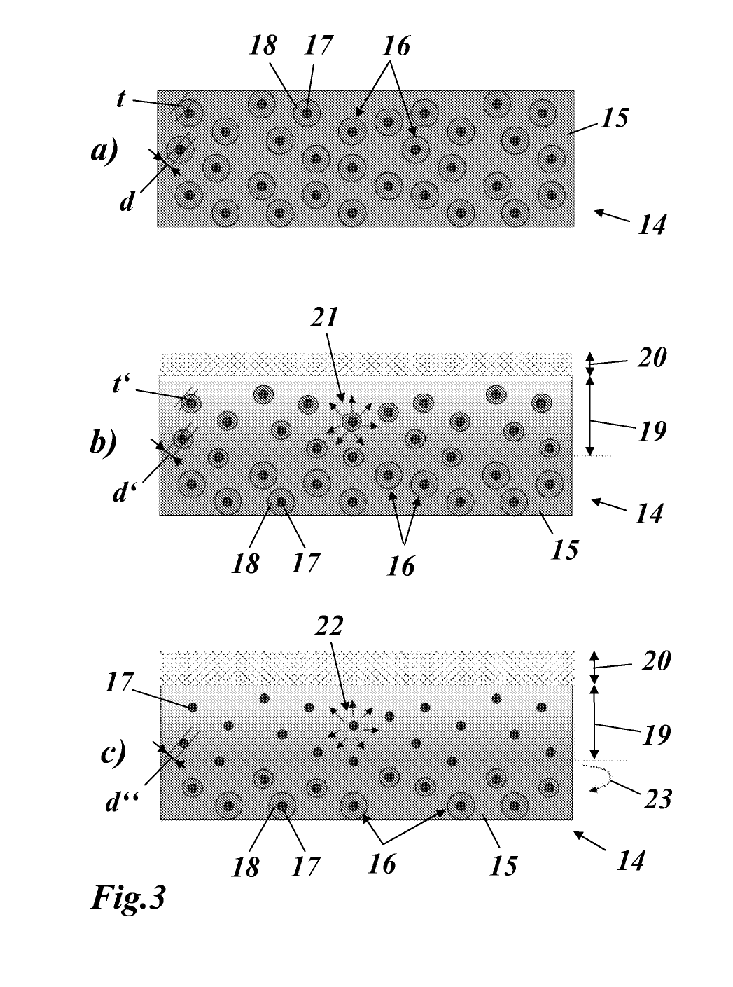

FIG. 3 shows different phases during the lifetime of a component with a healing system according to a first concept of the invention;

FIG. 4 shows different phases during the lifetime of a component with a healing system according to a second concept of the invention;

FIG. 5 shows different phases during the lifetime of a component with a healing system according to a third concept of the invention;

FIG. 6 shows different phases during the lifetime of a component with a healing system according to a fourth concept of the invention;

FIG. 7 shows an embodiment of the invention with an additional reservoir phase; and

FIG. 8 shows an embodiment of the invention, where fibres are used as a crack stopping means.

### DETAILED DESCRIPTION

An embodiment of the present invention provides a new and different solution to the problems described in order to extend the lifetime and/or to reduce the reconditioning efforts and scrap rate for components in turbomachines.

In an embodiment, an aspect of the present invention provides a component for a turbomachine or another engine containing a hot component, which substantially and effectively extends its lifetime with respect to crack formation, crack propagation and the healing of cracks.

In an embodiment, an aspect of the invention provides methods for manufacturing such a component.

The component according to the invention, which is used in a turbomachine, in particular a gas turbine, or other engines containing hot components and which is prone to crack formation and propagation by being subjected to high temperatures and/or a corrosive and/or oxidising atmosphere and/or a high mechanical load and/or cyclic thermal load and/or transient conditions, contains at least one base material. The inventive component is characterized in that said at least one base material is provided with a self healing system in form of an added active phase, whereby said active phase comprises a melting point depressant and/or a substance or substances with a softening or melting point below or within the range of the operating temperature of the component.

According to one embodiment of the invention said active phase has the form of individual particles, which are dispersed within the base material.

Particularly, said particles may be dispersed within the base material in a graded manner.

According to another embodiment of the invention said active phase has the form of fibres, which are incorporated into the base material.

Particularly, said fibres may be in a woven form.

Preferably, said particles and/or fibres each have a structure with a central core, which is enclosed by a shell.

In particular, said central core and said shell are made of chemical substances in the form of ceramics or metals or combinations thereof.

Especially, the chemical substances of the central core have the following characteristics:
a) decrease the melting point of the base material so that softening occurs at operating temperature, or have a low softening or melting temperature, preferably <1000° C.;
b) diffuse into the base material and/or optionally into the cracks;
c) do not strongly oxidise when present at the surface in contact with oxygen;
d) are able to chemically dissolve metal oxides;
e) have a limited reactivity with Cr in order to avoid a decrease of the corrosion resistance;
f) do not react with the substance of the shell.

Preferably, the chemical substances of the central core comprise one of Boron, Carbon, Phosphorous, Silicon, Nickel or a combination thereof, and react with the base material, thereby reducing the melting temperature.

Furthermore, the chemical substances of the central core may have a softening or melting point below or within the range of the operating temperature of the component and do not react with the base material.

Especially, the chemical substances of the shell have the following characteristics:
a) diffuse slowly in order to liberate the core substances or break and liberate the core substances;
b) do not react with the core substances;
c) have a limited reactivity with Cr in order to avoid a decrease of the corrosion resistance.

Preferably, the chemical substances of the shell comprise Chromium, or Nickel, or Aluminium or a combination thereof.

According to another embodiment of the invention the self-healing system of the component further comprises an additional reservoir phase in order to balance the composition and achieve a constant optimum concentration of chemical substances within the component.

In particular, the reservoir phase is in the form of individual particles, which are dispersed on top of and/or within the base material and each have a structure with a central core, which is enclosed by a shell.

Preferably, the core substances and/or the shell substances of the reservoir phase comprise Chromium, or Nickel, or Aluminium or a combination thereof.

A first method for manufacturing a component according to the invention, which component has a bond coat, preferably made of MCrAlY (M=Fe or Ni or Co or combinations thereof) and, is characterised in that, in a first step bond coat particles and particles of the active phase are dispersed, and in a second step the dispersed material is sprayed onto the component with a Thermal Spray process, especially a High Velocity Oxy Fuel (HVOF) process or an Air Plasma Spraying (APS) process or a Suspension Plasma Spray (SPS), or with a slurry coating process.

A second method for manufacturing a component according to the invention, which component has the form of a coupon made of a base material, preferably a superalloy, for example a Ni base superally, is characterized in that, in a first step particles of the base material and particles of the active phase are dispersed, and in a second step the dispersed material is processed by means of casting, or of any laser technique, especially Selective Laser Melting (SLM) or Selective Laser Sintering (SLS), or of any additive manufacturing technique.

A third method for manufacturing a component according to the invention, which component has a brazed joint, is characterized in that a braze sheet or tape or paste is used, which contains said active phase.

In an embodiment, the present invention provides a self healing system for the base material, brazed regions and/or coatings of components based on the addition of melting point depressants and/or substances with a softening or melting point below or within the range of the operating temperature according to the concept of the invention. The invention can be mitigation for crack formation and propagation due to (but not limited to it):

corrosion

and/or oxidation

and/or grain boundary coarsening due to precipitation

and/or creep

and/or low cycle fatigue

and/or high cycle fatigue

and/or thermal mechanical fatigue.

In an embodiment, the system can also heal the cracks already formed.

The advantages of an embodiment of the invention comprise an increase of the lifetime, and/or a reduction of the reconditioning effort related to crack restoration and/or a decrease of the scrap rate and/or a decrease of the operation risk achieved by preventing cracks and/or slowing down crack propagation rate and/or healing the cracks.

In general, an embodiment of the invention has the technical goals of preventing crack formation and/or preventing crack propagation and/or curing/healing existing cracks.

In an embodiment, the invention is applicable to newly made and/or reconditioned components within turbomachines, preferably (but not only) gas turbine hot gas path blades and vanes, as well as heat shields and liners, or hot components of other engines. The invention focuses on metallic or ceramic coatings on the whole component, coatings on a coupon, which is a part of a component but manufactured separately from the rest of the component, on the coupon itself, on braze joints used to fix a coupon, and the braze material used for repair.

In the explanations given below, the target components without a self healing system are referred to as “base materials”.

In an embodiment, the self healing system of the invention can be added completely, partially (for example only within the top surface) or on the top of the base materials. Furthermore, the self healing system of the invention can be added to the base material in a graded manner.

The component according to an embodiment of the invention is the least one base material together with the active phase and optionally with the reservoir phase. The base material is around the active (and the reservoir) phase. The component can be for example a coating, a coupon, a braze joint or part of a vane, blade, liner etc.

According to an embodiment of the invention, the self healing system comprises an active phase. In particular, this active phase has particles with potentially different shapes and/or fibers, which are optionally woven. The particles or fibers preferably have a core/shell structure. The core and shell can be made of chemical substances like non oxide or oxide ceramics, metals or combinations thereof.

In an embodiment, the chemical substances of the core have preferably the following characteristics:
a) decrease the melting point of the base material so that softening occurs at operating temperature or have a low (<1000° C.) softening or melting temperature;
b) diffuse into the base material and/or optionally into the cracks;
c) do not strongly oxidize when present at the surface in contact with oxygen;
d) are able to chemically dissolve the metal oxides;
e) have a limited reactivity with Cr in order to avoid a decrease of the corrosion resistance; and
f) do not react with the shell substance.

Furthermore, in an embodiment, the chemical substances from the core may be solid or liquid at the operating temperature. They may react with the base material, or not.

In an embodiment, the chemical substances of the shell, on the other hand, have the following characteristics:
a) diffuse slowly in order to liberate the core substances or break and liberate the core substances;
b) do not react with the core substances; and
c) have a limited reactivity with Cr in order to avoid a decrease of the corrosion resistance.

Optionally, an additional reservoir phase, which may also have a core/shell structure, might be needed in order to balance the composition and achieve a constant optimal concentration of chemical substances (in particular the concentration of Chromium is important for the corrosion protection).

In an embodiment, for the active phase with its core/shell structure, the core substances can be so-called melting point depressants (MDP) like Boron, Carbon, Phosphorous, Silicon, Nickel or a combination thereof. On the other hand, the core may be of a material with a softening or melting temperature below or in the range of the operating temperature according to the invention.

In an embodiment, the MDPs preferably react with the base material in order to reduce the melting temperature. Materials with a softening or melting temperature below or in the range of the operating temperature preferably do not react with the base material.

In an embodiment, the shell substances of the active phase can be Chromium or Nickel or Aluminium or a combination thereof.

In an embodiment, for the above-mentioned reservoir phase the core substances can be Chromium or Nickel or Aluminium or a combination thereof.

In an embodiment, the shell substances of the reservoir phase can also be Chromium or Nickel or Aluminium or a combination thereof.

In an embodiment, for the processing of the base material with the self healing system, different methods are applicable:
For a coating with a self healing system the active phase and the bond coat particles, for example MCrAlY particles, are dispersed (mixture of both powders or suspension of both powders) and then sprayed with High Velocity Oxy Fuel (HVOF), a standard process to apply a bond coat, or Air Plasma Spray (APS), or Suspension Plasma Spray (SPS), or slurry coating or another process to apply a coating.
For a coupon with a self healing system the active phase and the base material particles, for example superalloy particles, are dispersed (mixture of both powders or suspension of both powders) and processed by means of casting, Selective Laser Melting (SLM) or Selective Laser Sintering (SLS), or any other laser technique, or any additive manufacturing technique.
For a brazed joint with a self healing system a braze sheet or tape or paste with self healing particles or fibers is used.

Within the scope of the invention, there are many more alternatives for processing base material with self healing system according to the invention.

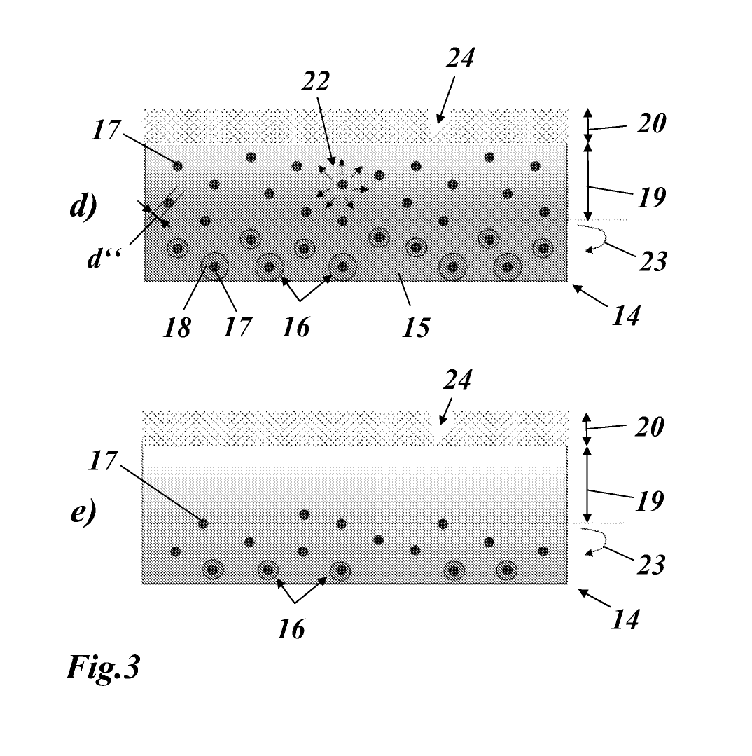

With respect to FIGS. 3 to 8, various concepts of the base material plus healing system according to the invention will be explained.

FIG. 3(a)-(e) is related to the case or concept of prevention of crack formation by softening and damping:

FIG. 3(a) shows the initial situation, i.e. at the installation of the component in the turbomachine. The component 14 comprises a base material 15, for example a metallic material or a ceramic material, and contains dispersed particles 16 of an active phase, each of the particle 16 has a core 17 enclosed by a shell 18. The shell 18 has an initial shell thickness t. The core 17 has an initial core diameter d; however, the shape of the core can be non-spherical or arbitrary and d then means equivalent diameter of the core volume.

After several hours of operation (FIG. 3(b)) oxidation of the surface of the component 14 results in a depletion zone 19 and an oxide layer 20. The gradient of concentration is the driving force for diffusion 21 of the chemical substances from the shell resulting in a thinner shell. The shell thickness after several hours of operation, t′, is smaller than t (t′<t). The core diameter after several hours of operation, d′, is equal to d (d′=d).

After several additional hours of operation (FIG. 3(c)) all the shell substances are dissolved into the base material 15. Now, the core substance is liberated by diffusion 22. The base material 15 becomes softer (incipient melting) or locally liquid at the service temperature. One (among several others) mechanism for crack prevention is a damping effect for vibrations produced by viscous dissipation properties of the liquated material. The core diameter, d″, is smaller than d′. There is an extension 23 of the depletion zone 19.

After several additional hours of operation (FIG. 3(d)) the region of the depletion zone 19 shows the self healing effect: The base material 15 is softened enough in order to prevent crack formation or is healing a crack 24 simultaneously.

At the end of the lifetime of the component 14 (FIG. 3(e)) the effect is extended together with the extension 23 of the depletion zone 19. Self-maintenance of the process is established by consumption of the surface (oxide layer 20) and propagation of the depletion zone 19.

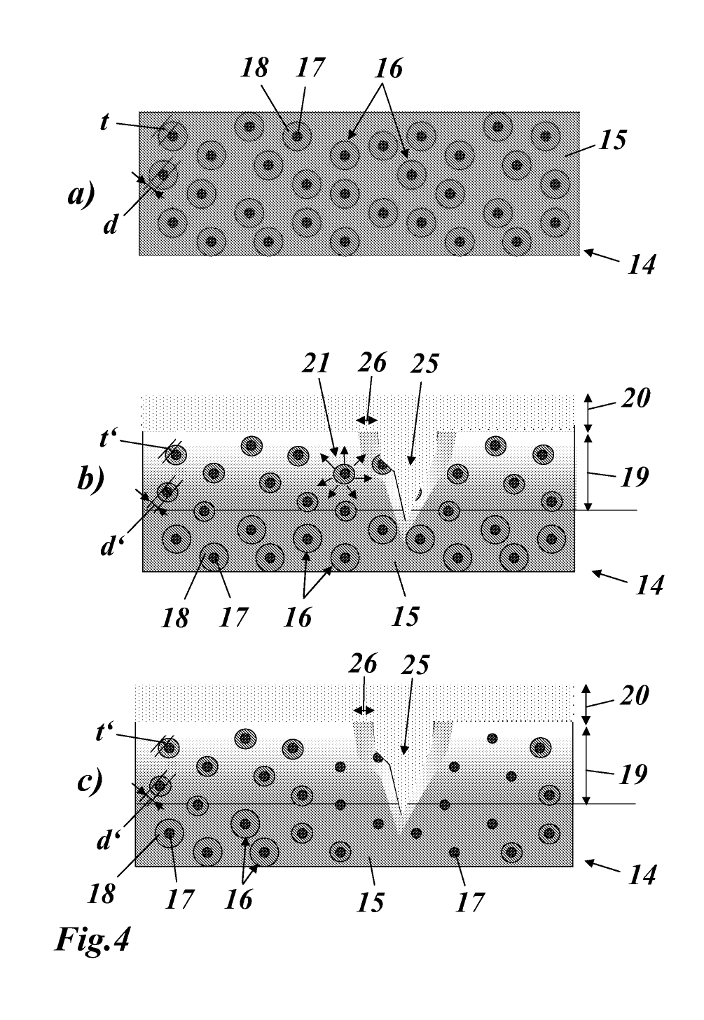

FIG. 4(a)-(d) is related to the case or concept of prevention of large crack formation/propagation:

FIG. 4(a) again shows the initial situation, i.e. at the installation of component in the turbomachine. The component 14 comprises a base material 15 and contains dispersed particles 16 of an active phase. Each of the particle 16 has a core 17 enclosed by a shell 18. The shell 18 has an initial shell thickness t. The core 17 has an initial core diameter d.

After several hours of operation (FIG. 4(b)) there is the formation of large cracks 25 in the base material 15. The oxidation of the crack surface results in a crack-related depletion zone 26. The gradient of concentration in the main depletion zone 19 is the driving force for diffusion 21 of the chemical substances contained in the shell 18 resulting in a thinner shell.

After several additional hours of operation (FIG. 4(c)) the chemical substances from the core 17 are liberated resulting in a softening or a melting point reduction within the depleted area 19. Propagation of the cracks 25 is stopped or at least slowed down.

At the end of the lifetime (FIG. 4(d)) self-maintenance of the process is established by consumption of the surface (oxide layer 20) and propagation of the depletion zone 19 (extension 23).

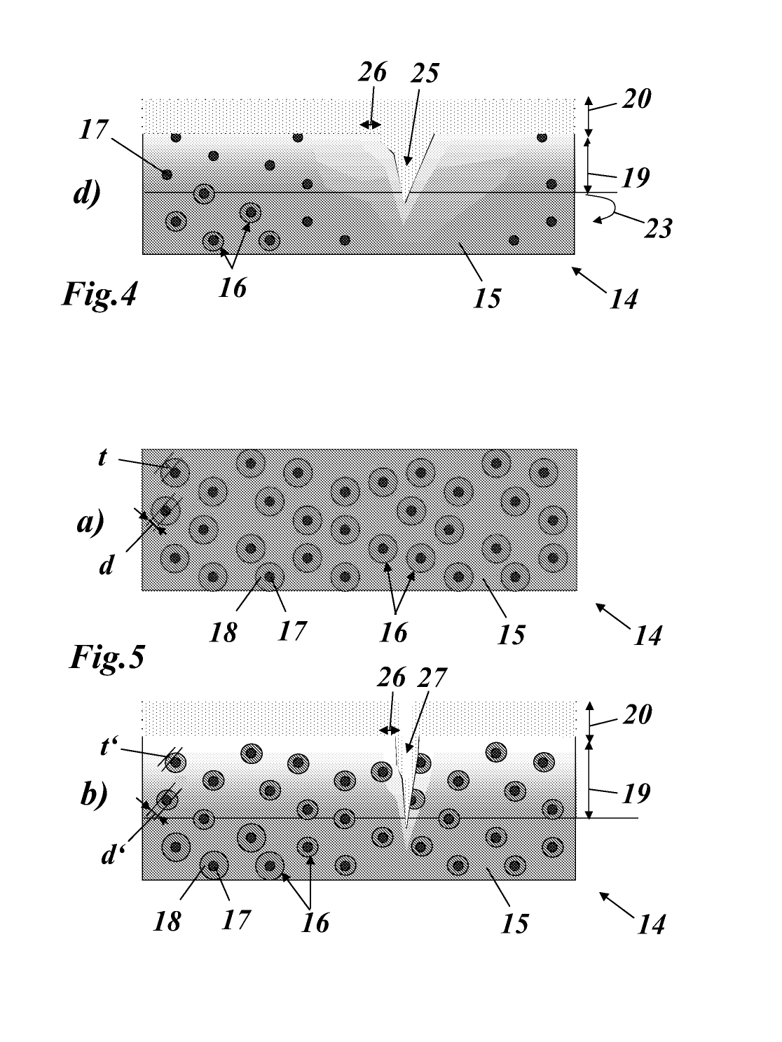

FIG. 5(a)-(e) is related to the case or concept of fine crack healing:

FIG. 5(a) again shows the initial situation, i.e. at the installation of the component in the turbomachine. The component 14, which comprises a base material 15, contains dispersed particles 16, each of which has a core 17 enclosed by a shell 18. The shell 18 has an initial shell thickness t. The core 17 has an initial core diameter d.

After several hours of operation (FIG. 5(b)) there is a formation of fine cracks 27. In addition, an oxide layer 20 and first and second depletion zones 19 and 26 are formed.

Then, after several additional hours of operation (FIG. 5(c)) a diffusion of substances from the shell 18 takes place.

After several additional hours of operation (FIG. 5(d)) there is a dissolution of metal oxides, which might have formed in the crack 27, by the liberation of the substance from the core 17.

After several additional hours of operation (FIG. 5(e)) there is a softening and/or melting due to the liberation of the core substances and/or liberation of liquid substances. There is a filling 28 of the crack and local re-oxidation at the initial crack position.

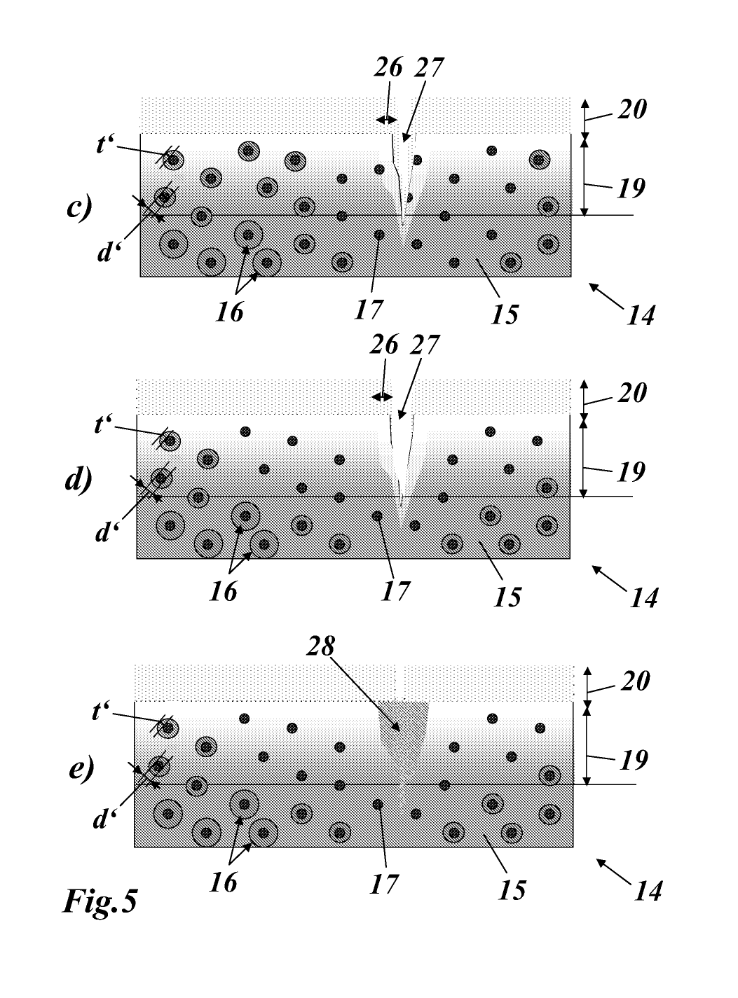

FIG. 6(a)-(c) is related to the case or concept of crack prevention and crack healing:

FIG. 6(a) again shows the initial situation, i.e. at the installation of the component in the turbomachine. The component 14, which comprises a base material 15, contains dispersed particles 16, each of which has a core 17 enclosed by a shell 18. The shell 18 has an initial shell thickness t. The core 17 has an initial core diameter d, meaning the equivalent diameter in case of arbitrary, non-spherical volume of the core.

After several hours of operation (FIG. 6(b)) an oxide layer 20 and a depletion zone 19 are formed. Furthermore, there is a coarsening of the grain boundaries 30 by precipitation in the base material 15. At the same time, diffusion 29 from the shell 18 takes place.

After several additional hours of operation (FIG. 6(c)) cracks tend to form in the prolongation of the coarsened grain boundaries 30 (crack formation zone 31). Cracks are avoided or simultaneously self healed.

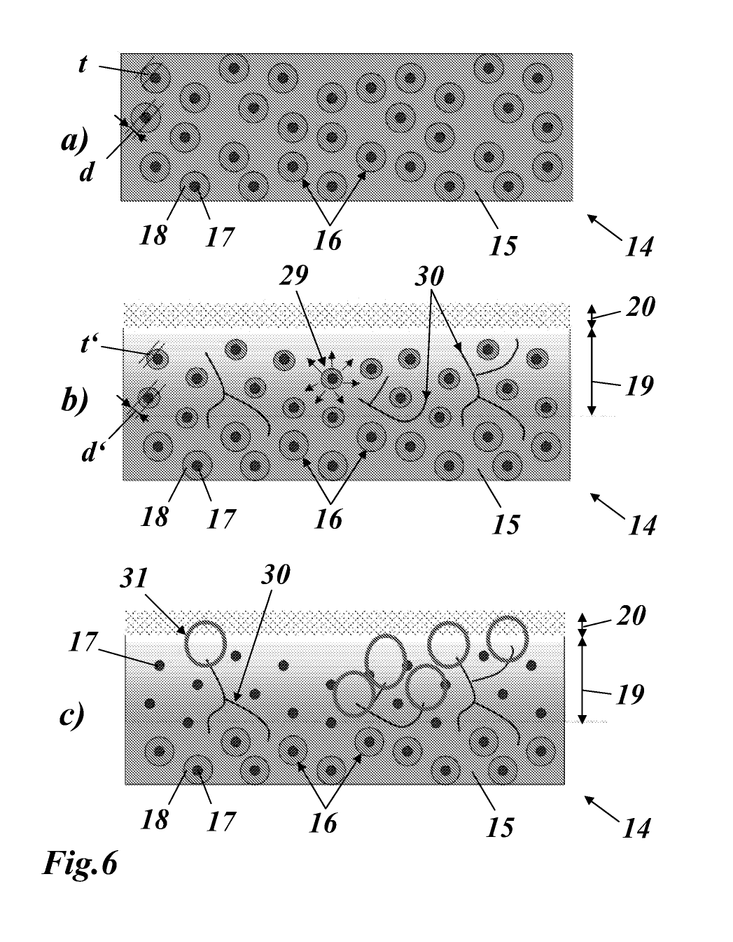

FIG. 7 is related to a concept, which can be additionally applied to the other concepts explained above. It shows the initial situation, i.e. at the installation of the component in the turbomachine. The component 14, which comprises a base material 15, contains dispersed particles 16, each of which has a core 17 enclosed by a shell 18. Further to the active phase (particles 16) there is dispersed a reservoir phase comprising particles 32 with a core/shell structure with core 33 and shell 34.

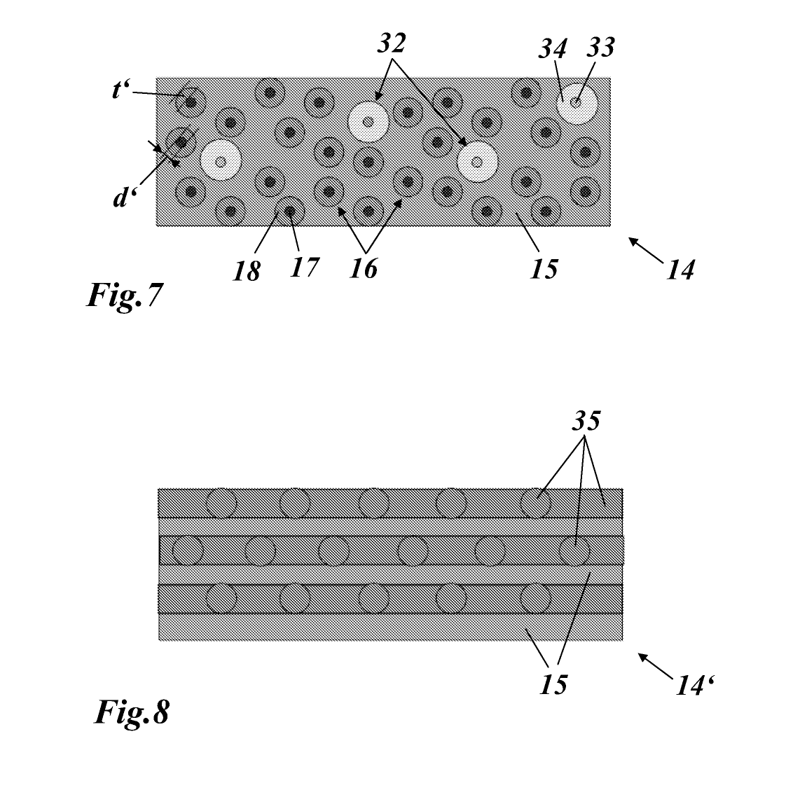

Finally, FIG. 8 is related to a concept of the control of crack propagation, wherein the base material 15 of the component 14′ is reinforced with fibers 35.

The role of the (preferably woven) fibers 35 is to mechanically stop the crack propagation and/or to orient them in directions of lower load. The stress peaks are redistributed in a more favorable direction. The fibers 35 may act as an active phase, as explained before.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

### LIST OF REFERENCE NUMERALS

10 thermal barrier coating (TBC)
11 bond coat
12 base metal (substrate)
13 crack
14,14′ component
15 base material
16 particle (active phase)
17,33 core
18,34 shell
19,26 depletion zone
20 oxide layer
21,29 shell diffusion
22 core diffusion
23 extension (depletion zone)
24,25,27 crack
28 filling
30 grain boundary
31 crack formation zone
32 particle (reservoir phase)
25 fibre (active phase)
d,d′,d″ core diameter (or equivalent diameter in case of arbitrary, non-spherical volume)
t,t′ ,t″ shell thickness (or equivalent thickness in case of arbitrary, non-spherical volume)

What is claimed is:

1. A component for use in an engine in which the component is subjected to at least one of a high temperature, a corrosive atmosphere, an oxidizing atmosphere, a high mechanical load, a cyclic thermal load and transient conditions such that the component is prone to crack formation and propagation, the component comprising:
at least one base material including a self healing system, the self healing system including an added active phase including at least one of a melting point depressant and a substance having a softening or a melting point below or within a range of an operating temperature of the component.

2. The component as recited in claim 1, wherein the engine includes a turbomachine.

3. The component as recited in claim 1, wherein the active phase includes individual particles dispersed within the base material.

4. The component as recited in claim 3, wherein the particles are dispersed within the base material in a graded manner.

5. The component as recited in claim 1, wherein the active phase includes fibres incorporated into the base material.

6. The component as recited in claim 5, wherein the fibres are woven.

7. The component as recited in claim 1, wherein the active phase includes at least one of particles dispersed within the base material and fibres incorporated into the base material, the at least one of the particles and fibres each have a structure including a central core enclosed by a shell.

8. The component as recited in claim 7, wherein the central core and the shell include chemical substances in a form of at least one of a ceramic and a metal.

9. The component as recited in claim 8, wherein the chemical substances of the central core are configured to
a) decrease the melting point of the base material such that a softening of the base material occurs;
b) diffuse into at least one of the base material and a crack;
c) not strongly oxidize when present at a surface in contact with oxygen;
d) chemically dissolve metal oxides;
e) have a limited reactivity with Cr to avoid a decrease of a corrosion resistance; and
f) not react with the chemical substances of the shell.

10. The component as recited in claim 9, wherein the chemical substances of the central core include at least one of Boron, Carbon, Phosphorous, Silicon and Nickel and are configured to react with the base material so as to reduce the melting point of the base material.

11. The component as recited in claim 9, wherein the chemical substances of the central core do not react with the base material.

12. The component as recited in claim 8, wherein the chemical substances of the shell are configured to
a) diffuse slowly to liberate the chemical substances of the central core;
b) not react with the chemical substances of the central core; and
c) have a limited reactivity with Cr to avoid a decrease of a corrosion resistance.

13. The component as recited in claim 12, wherein the chemical substances of the shell include at least one of Chromium, Nickel and Aluminium.

14. The component as recited in claim 7, wherein the self-healing system includes a reservoir phase configured to balance a composition and achieve a constant optimum concentration of the chemical substances within the component.

15. The component as recited in claim 14, wherein the reservoir phase includes individual particles dispersed at least one of on top of and within the base material, each of the individual particles having a structure with a central core enclosed by a shell.

16. The component as recited in claim 15, wherein substances of at least one of the central core and the shell include at least one of Chromium, Nickel and Aluminium.

17. A method for manufacturing a component for an engine in which the component is subjected to at least one of a high temperature, a corrosive atmosphere, an oxidizing atmosphere, a high mechanical load, a cyclic thermal load and transient conditions such that the component is prone to crack formation and propagation, the method comprising:
dispersing bond coat particles and active phase particles so as to form a dispersed material; and
spraying the dispersed material onto the component using at least one of a Thermal Spray, Suspension Plasma Spray and a slurry coating process.

18. A method for manufacturing a component in a form of a coupon including a base material for an engine in which the component is subjected to at least one of a high temperature, a corrosive atmosphere, an oxidizing atmosphere, a high mechanical load, a cyclic thermal load and transient conditions such that the component is prone to crack formation and propagation, the method comprising:
dispersing base material particles and active phase particles so as to form a dispersed material; and
processing the dispersed material using at least one of casting, laser technique and an additive manufacturing technique.

19. The method as recited in claim 17, wherein the component includes a brazed joint, the brazing material including the active phase particles and in a form of one of a braze sheet, tape and paste.
